(19) United States
(12) Patent Application Publication
(10) Pub. No.: US 2025/0036885 A1
(43) Pub. Date: Jan. 30, 2025

(54) LANGUAGE MODEL PROCESSING METHOD AND DEVICE, STORAGE MEDIUM

(71) Applicant: Beijing Volcano Engine Technology Co., Ltd., Beijing (CN)

(72) Inventors: Guolong SONG, Beijing (CN); Xuan LUO, Beijing (CN)

(21) Appl. No.: 18/758,669

(22) Filed: Jun. 28, 2024

(30) Foreign Application Priority Data
Jul. 26, 2023 (CN) 202310925971.6

(51) Int. Cl. G06F 40/40

(52) U.S. Cl. CPC G06F 40/40

(57) ABSTRACT

The present application discloses a language model processing method and apparatus. The method includes: constructing N storage structures to store an N-gram language model. For an ith structure, if i is greater than or equal to 1 and less than or equal to N−1, the ith storage structure includes a plurality of first nodes, the first node is used to carry information about an ith-order word in a first gram; or if i is equal to N, the ith storage structure includes a plurality of second nodes, the second node carries information about a second gram, the second gram is an N-gram, and the information carried by the second node includes: an identifier of an Nth-order word in the second gram and an N-gram probability of the second gram.

### CROSS-REFERENCE TO RELATED APPLICATION

The present application claims priority of the Chinese Patent Application No. 202310925971.6, filed on Jul. 26, 2023, the disclosure of which is incorporated herein by reference in the present application.

### TECHNICAL FIELD

The present application relates to the field of data processing, and in particular, to a language model processing method and an apparatus.

### BACKGROUND

N-gram language model, a common technique in statistical natural language processing, is used for modeling a relationship between words in a sentence. A basic idea of the N-gram language model is providing a statistical probability of the occurrence of an Nth word given its previous N−1 words, where N is referred to as an “order” of the model.

The N-gram language model may be used for many natural language processing tasks, such as speech recognition, text generation, machine translation, and information retrieval. A typical scenario is text generation, in which k words with the highest probabilities in the N-gram language model are used as candidates for the Nth word based on the previous N−1 words.

Currently, a huge amount of data needs to be stored for the N-gram language model, which results in low storage performance. Therefore, there is an urgent need for a solution that can solve the above problem.

### SUMMARY

In order to solve or at least partially solve the above technical problem, embodiments of the present application provide a language model processing method and apparatus.

According to a first aspect, an embodiment of the present application provides a language model processing method. The method includes:
constructing N storage structures for an N-gram language model, where N is an integer greater than or equal to 2; and
storing the N-gram language model based on the N storage structures, where
for an ith structure of the N storage structures:
when i is greater than or equal to 1 and less than or equal to N−1, the ith storage structure includes a plurality of first nodes, each first node is used to carry information about an ith-order word in a first gram, the first gram is an i-gram, and the information carried by the first node includes: an identifier of the ith-order word in the first gram, an i-gram probability of the first gram, and a storage location of information about (i+1)th-order words in a plurality of (i+1)-grams that each use the first gram as first i orders of words in an (i+1)th storage structure, where the i-gram includes i words, the ith-order word in the i-gram is an ith word in the i-gram, the (i+1)-gram includes i+1 words, and the (i+1)th-order word in the (i+1)-gram is an (i+1)th word in the (i+1)-gram; or
when i is equal to N, the ith storage structure includes a plurality of second nodes, each second node is used to carry information about a second gram, the second gram is an N-gram, and the information carried by the second node includes: an identifier of an Nth-order word in the second gram and an N-gram probability of the second gram.

Optionally, the N storage structures are arrays, and an identifier of the first gram carried by the first node in a first array of the N arrays is a subscript of an element corresponding to the first node in the array.

Optionally, the information about the (i+1)th-order words in the plurality of (i+1)-grams that each use the first gram as the first i orders of words is continuously stored in the (i+1)th storage structure, and the storage location includes: a start storage location and an end storage location.

Optionally, the storing the N-gram language model based on the N storage structures includes:
writing to a first storage structure first; and
when i is greater than or equal to 1 and less than or equal to N−1, for information about each first gram stored in the ith storage structure, writing the information about the (i+1)th-order words in the plurality of (i+1)-grams that each use the first gram as the first i orders of words to the (i+1)th storage structure according to a storage sequence in the ith storage structure.

Optionally, the method further includes:
obtaining a target search gram, where the target search gram is an M-gram, and M is less than or equal to N; and
finding a first target node in a first storage structure by using an identifier of a first-order word of the M-gram as an index, and obtaining information carried by the first target node.

Optionally, when M is greater than or equal to 2, the method further includes:
when i is greater than or equal to 1 and less than or equal to M−1, determining nodes to be retrieved in the (i+1)th storage structure based on a storage location in information carried by a second target node found in the ith storage structure;
finding a third target node in the nodes to be retrieved by using an identifier of an (i+1)th-order word of the M-gram as an index, and obtaining information carried by the third target node; and
determining information carried by the third target node found in an Mth storage structure as a query result.

Optionally, the method further includes:
outputting information carried by each of the nodes to be retrieved in the Mth storage structure.

According to a second aspect, an embodiment of the present application provides a language model processing apparatus. The apparatus includes:
a construction unit configured to construct N storage structures for an N-gram language model, where N is an integer greater than or equal to 2; and
a storage unit configured to store the N-gram language model based on the N storage structures, where
for an ith structure of the N storage structures:
when i is greater than or equal to 1 and less than or equal to N−1, the ith storage structure includes a plurality of first nodes, each first node is used to carry information about an ith-order word in a first gram, the first gram is an i-gram, and the information carried by the first node includes: an identifier of the ith-order word in the first gram, an i-gram probability of the first gram, and a storage location of information about (i+1)th-order words in a plurality of (i+1)-grams that each use the first gram as first i orders of words in an (i+1)th storage structure, where the i-gram includes i words, the ith-order word in the i-gram is an ith word in the i-gram, the (i+1)-gram includes i+1 words, and the (i+1)th-order word in the (i+1)-gram is an (i+1)th word in the (i+1)-gram; or
when i is equal to N, the ith storage structure includes a plurality of second nodes, each second node is used to carry information about a second gram, the second gram is an N-gram, and the information carried by the second node includes: an identifier of an Nth-order word in the second gram and an N-gram probability of the second gram.

Optionally, the N storage structures are arrays, and an identifier of the first gram carried by the first node in a first array of the N arrays is a subscript of an element corresponding to the first node in the array.

Optionally, the storage unit is configured to:
write to a first storage structure first; and
when i is greater than or equal to 1 and less than or equal to N−1, for information about each first gram stored in the ith storage structure, write the information about the (i+1)th-order words in the plurality of (i+1)-grams that each use the first gram as the first i orders of words to the (i+1)th storage structure according to a storage sequence in the ith storage structure.

Optionally, the apparatus further includes:
an obtaining unit configured to obtain a target search gram, where the target search gram is an M-gram, and M is less than or equal to N; and
a first search unit configured to find a first target node in a first storage structure by using an identifier of a first-order word of the M-gram as an index, and obtain information carried by the first target node.

Optionally, when M is greater than or equal to 2, the apparatus further includes:
a first determination unit configured to: when i is greater than or equal to 1 and less than or equal to M−1, determine nodes to be retrieved in the (i+1)th storage structure based on a storage location in information carried by a second target node found in the ith storage structure;
a second search unit configured to find a third target node in the nodes to be retrieved by using an identifier of an (i+1)th-order word of the M-gram as an index, and obtain information carried by the third target node; and
a second determination unit configured to determine information carried by the third target node found in an Mth storage structure as a query result.

Optionally, the apparatus further includes:
an output unit configured to output information carried by each of the nodes to be retrieved in the Mth storage structure.

According to a third aspect, an embodiment of the present application provides a device. The device includes a processor and a memory.

The processor is configured to execute instructions stored in the memory to cause the device to perform the method of any one of the embodiments of the first aspect above.

According to a fourth aspect, an embodiment of the present application provides a computer-readable storage medium, including instructions to instruct a device to perform the method of any one of the embodiments of the first aspect above.

According to a fifth aspect, an embodiment of the present application provides a computer program product, which, when running on a computer, causes the computer to perform the method of any one of the embodiments of the first aspect above.

### BRIEF DESCRIPTION OF DRAWINGS

In order to more clearly describe the technical solutions in the embodiments of the present application or in the prior art, the drawings for describing the embodiments or the prior art will be briefly described below. Apparently, the drawings in the description below show merely some embodiments recited in the present application, and persons of ordinary skill in the art may still derive other drawings from these drawings without creative efforts.

FIG. 1 is a schematic flowchart of a language model processing method according to an embodiment of the present application;

FIG. 2 is a schematic diagram of a storage structure according to an embodiment of the present application;

FIG. 3 is a schematic flowchart of a retrieval method according to an embodiment of the present application;

FIG. 4 is a schematic flowchart of another retrieval method according to an embodiment of the present application; and

FIG. 5 is a schematic diagram of a structure of a language model processing apparatus according to an embodiment of the present application.

### DETAILED DESCRIPTION

In order for persons skilled in the art to better understand the solutions of the present application, the technical solutions in the embodiments of the present application will be described below clearly and completely with reference to the accompanying drawings in the embodiments of the present application. Apparently, the embodiments described are merely some rather than all of the embodiments of the present application. All other embodiments obtained by persons of ordinary skill in the art based on the embodiments of the present application without creative efforts fall within the scope of protection of the present application.

In conventional technologies, an N-gram language model is typically stored in a key-value format. A key stores context information. For example, w1-w2-w3 may be used as a key in a trigram language model. A value stores information about a probability of the key. Herein, w1, w2, and w3 are a first word, a second word, and a third word, respectively, and “-” is a separator.

In the current storage manner of the language model, a huge amount of data needs to be stored for the N-gram language model, which results in low storage performance. For example, for two keys, namely, w1-w2-w3 and w1-w2-w4, w1 and w2 are stored repeatedly.

In addition, in a scenario of text generation, the language model has low retrieval performance. If k words with the highest probabilities are to be obtained, multiple retrieval operations need to be performed to cover all possible cases, thereby determining the k words with the highest probabilities.

In order to solve the above problem, the embodiments of the present application provide a language model processing method and apparatus.

Various non-limiting implementations of the present application will be described in detail below with reference to the accompanying drawings. The embodiments of the present application provide a language model processing method. The method includes: constructing N storage structures for an N-gram language model, where N is an integer greater than or equal to 2. For an ith structure of the N storage structures, if i is greater than or equal to 1 and less than or equal to N−1, the ith storage structure includes a plurality of first nodes, where each first node is used to carry information about an ith-order word in a first gram, the first gram is an i-gram, and the information carried by the first node includes: an identifier of the ith-order word in the first gram, an i-gram probability of the first gram, and a storage location of information about (i+1)th-order words in a plurality of (i+1)-grams that each use the first gram as first i orders of words in an (i+1)th storage structure, where the i-gram includes i words, the ith-order word in the i-gram is an ith word in the i-gram, the (i+1)-gram includes i+1 words, and the (i+1)th-order word in the (i+1)-gram is an (i+1)th word in the (i+1)-gram; or when i is equal to N, the ith storage structure includes a plurality of second nodes, each second node is used to carry information about a second gram, the second gram is an N-gram, and the information carried by the second node includes: an identifier of an Nth-order word in the second gram and an N-gram probability of the second gram. After the N storage structures are constructed, the N-gram language model may be stored based on the N storage structures. In the embodiments of the present application, in a case in which there are a plurality of grams, even if the first word or the first few words of the plurality of grams are the same, the same part may be stored only once rather than repeatedly. Therefore, with this solution, a storage capacity for the N-gram language model can be effectively saved, thereby improving the storage performance.

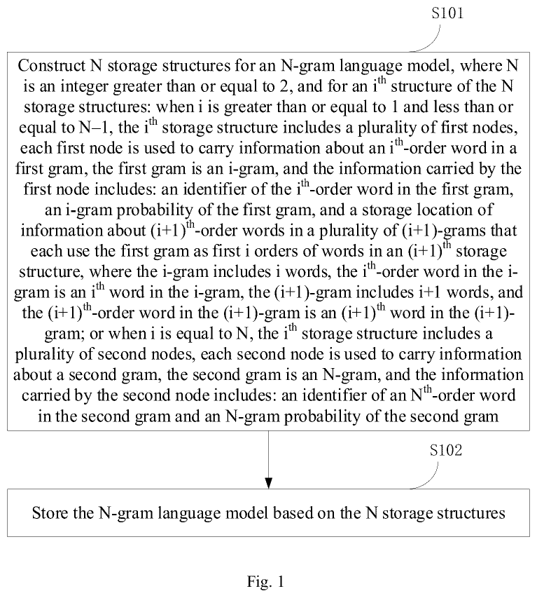

FIG. 1 is a schematic flowchart of a language model processing method according to an embodiment of the present application. In this embodiment, the method may be applied to a client or a server, which is not specifically limited in the embodiments of the present application.

In an example, the method may include, for example, the following steps S101 and S102.

S101: Construct N storage structures for an N-gram language model, where N is an integer greater than or equal to 2, and for an ith structure of the N storage structures: when i is greater than or equal to 1 and less than or equal to N−1, the ith storage structure includes a plurality of first nodes, each first node is used to carry information about an ith-order word in a first gram, the first gram is an i-gram, and the information carried by the first node includes: an identifier of the ith-order word in the first gram, an i-gram probability of the first gram, and a storage location of information about (i+1)th-order words in a plurality of (i+1)-grams that each use the first gram as first i orders of words in an (i+1)th storage structure, where the i-gram includes i words, the ith-order word in the i-gram is an ith word in the i-gram, the (i+1)-gram includes i+1 words, and the (i+1)th-order word in the (i+1)-gram is an (i+1)th word in the (i+1)-gram; or when i is equal to N, the ith storage structure includes a plurality of second nodes, each second node is used to carry information about a second gram, the second gram is an N-gram, and the information carried by the second node includes: an identifier of an Nth-order word in the second gram and an N-gram probability of the second gram.

In this embodiment of the present application, a sequence of words involved in the N-gram language model is also referred to as an N-gram, where the N-gram is a gram including N words. For example, a trigram is a gram including three words, and the gram w1-w2-w3 may be considered as a trigram.

In this embodiment of the present application, for an N-gram, an ith word in the N-gram is also referred to as an ith-order word. For example, for the trigram w1-w2-w3, w1 is a first-order word of the trigram, w2 is a second-order word of the trigram, and w3 is a third-order word of the trigram.

In this embodiment of the present application, in order to avoid massive duplicate storage in storing the N-gram language model, N storage structures may be constructed for the N-gram language model, and one of the storage structures is used for storing information about a specific order of word. For example, for a trigram language model, three storage structures may be constructed, where a first storage structure is used for storing a first-order word, a second storage structure is used for storing a second-order word, and a third storage structure is used for storing a third-order word.

Next, the N storage structures will be described.

In this embodiment of the present application, each storage structure may include a plurality of nodes, and each node is used to carry information about a word.

For the N storage structures, content carried by nodes in the first N−1 storage structures is of the same type, and content carried by nodes in an Nth storage structure is of a type that is different from the type of the content carried by the nodes in the first N−1 storage structures.

For an ith structure of the N storage structures:
if i is greater than or equal to 1 and less than or equal to N−1, the ith storage structure may include a plurality of first nodes, where each first node is used to carry information about an ith-order word in a first gram, and the first gram is an i-gram. For example, when i is equal to 1, the first gram is a unigram, and the first node is used to carry information about a first-order word of the unigram. When i is equal to 2, the first gram is a bigram, and the first node is used to carry information about a second-order word of the bigram.

The first node is used to carry the information about the ith-order word in the first gram, and the information about the ith-order word in the first gram includes: an identifier of the ith-order word in the first gram, an i-gram probability of the first gram, and a storage location of information about (i+1)th-order words in a plurality of (i+1)-grams that each use the first gram as first i orders of words in an (i+1)th storage structure.

The identifier of the ith-order word in the first gram may be used to uniquely identify the ith-order word in the first gram.

The i-gram probability of the first gram is a conditional probability of the ith-order word of the first gram. For example, if the first gram is w1, the ith-order probability of the first gram may be: p(w1). If the first gram is w1-w2, the ith-order probability of the first gram may be: p(w2|w1). For another example, if the first gram is w1-w2-w3, the ith-order probability of the first gram may be: p(w3|w1w2). In an example, p(w1), p(w2|w1), and p(w3|w1w2) may be calculated according to formulas (1), (2), and (3) below, respectively.

$$p ( w 1 ) = n ( w 1 ) / n ( T ) \qquad formula ( 1 )$$

$$p ( w 2 \vert w 1 ) = n ( w 1 w 2 ) / n ( w 1 ) \qquad formula ( 2 )$$

$$p ( w 3 \vert w 1 w 2 ) = n ( w 1 w 2 w 3 ) / n ( w 1 w 2 ) \qquad formula ( 3 )$$

In formulas (1) to (3):
n(T) represents a frequency of all words;
n(w1) represents a frequency of the gram w1;
n(w1w2) represents a frequency of occurrence of the gram w1w2; and
n(w1w2w3) represents a frequency of occurrence of the gram w1w2w3. In this embodiment of the present application, there is a large number of (i+1)-grams that each use the first gram as the first i orders of words, and the information about the (i+1)th-order words in the plurality of (i+1)-grams that each use the first gram as the first i orders of words may be stored in an (i+1)th storage structure. The information carried by the first nodes may further include the storage location of the information about the (i+1)th-order words in the plurality of (i+1)-grams that each use the first gram as the first i orders of words in the (i+1)th storage structure.

In an example, the information about the (i+1)th-order words in the plurality of (i+1)-grams may be dispersedly stored in the (i+1)th storage structure, in which case the storage location of the information about the (i+1)th-order words in the plurality of (i+1)-grams in the (i+1)th storage structure may include a storage location corresponding to the information about the (i+1)th-order words in the (i+1)-grams in the (i+1)th storage structure.

In another example, the information about the (i+1)th-order words in the plurality of (i+1)-grams may be continuously stored in the (i+1)th storage structure, in which case the storage location of the information about the (i+1)th-order words in the plurality of (i+1)-grams in the (i+1)th storage structure may include a start storage location and an end storage location of the information about the (i+1)th-order words in the plurality of (i+1)-grams in the (i+1)th storage structure. In this case, when the information about the (i+1)th-order words in the plurality of (i+1)-grams that each use the first gram as the first i orders of words is retrieved, information about (i+1)th-order words in all (i+1)-grams that each use the first gram as the first i orders of words may be obtained from a continuous storage area in the (i+1)th storage structure, thereby improving the retrieval efficiency.

If i is equal to N, the ith storage structure includes a plurality of second nodes, each second node is used to carry information about a second gram, the second gram is an N-gram, and the information carried by the second node includes: an identifier of an Nth-order word in the second gram and an N-gram probability of the second gram.

For the N-gram probability, reference may be made to the above description of the i-gram probability, and details are not repeated herein. In an example, the N storage structures may be arrays, and the nodes (e.g., the first nodes or the second nodes) may correspond to elements in the arrays. As can be seen from the foregoing description, the ith storage structure includes the plurality of first nodes, each first node is used to carry the information about the ith-order word in the first gram, and the first gram is the i-gram. When i is equal to 1, the first gram is a unigram, and the first node is actually used to carry the information about the first gram. In this case, in an example, the identifier of the first gram carried by the first node in a first array may be a subscript of an element corresponding to the first node in the array. For example, if the first node corresponds to an element 1 in the first array, the element 1 corresponds to an array subscript a, and the first node is used to carry information about a gram b, an identifier of the gram b may be a. In this way, when the information about the first gram is queried in the first array, the identifier of the first gram may be directly used as the array subscript to read from the array, which can improve the efficiency of data query.

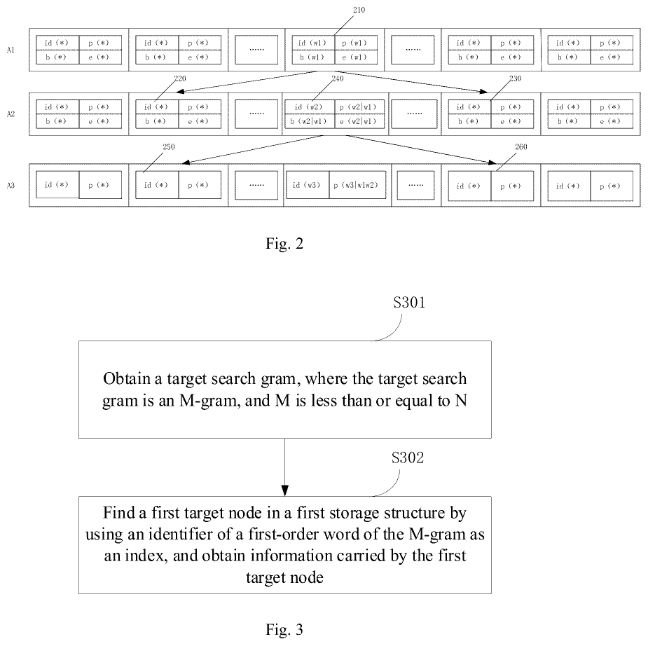

The N storage structures are described now by taking N=3 as an example. FIG. 2 is a schematic diagram of a storage structure according to an embodiment of the present application.

FIG. 2 shows three storage structures. A first storage structure A1 is used for storing information about a first-order word, a second storage structure A2 is used for storing information about a second-order word, and a third storage structure A3 is used for storing information about a third-order word.

As shown in FIG. 2, the first storage structure A1 includes a plurality of nodes, each node is used to store information about a first-order word of a unigram, and the information about the first-order word includes four parts, namely: an identifier (e.g., id(w1) shown in FIG. 2) of the first-order word, a unigram probability (e.g., p(w1) shown in FIG. 2) of the unigram, and a start storage location and an end storage location (e.g., b(w1) and e(w1) shown in FIG. 2) of information about second-order words of bigrams that each use the unigram as the first-order word in the second storage structure A2. As shown in FIG. 2, a start location in information carried by a node 210 may correspond to 220 and 230 in FIG. 2.

In an example, a length of the array A1 may be equal to a number m1 of unigrams enumerated.

The second storage structure A2 includes a plurality of nodes, each node is used to store information about a second-order word of a bigram, and the information about the second-order word of the bigram includes four parts, namely: an identifier (e.g., id(w2) shown in FIG. 2) of the second-order word, a bigram probability (e.g., p(w2|w1) shown in FIG. 2) of the bigram, and a start storage location and an end storage location (e.g., b(w1w2) and e(w1w2) shown in FIG. 2) of information about third-order words of trigrams that each use the bigram as the first two orders of words in the third storage structure A3. As shown in FIG. 2, a start location in information carried by a node 240 may correspond to 250 and 260 in FIG. 2.

In an example, a length of the array A2 may be equal to a number m2 of bigrams enumerated.

The third storage structure A3 includes a plurality of nodes, each node is used to store information about a third-order word of a trigram, and the information about the third-order word of the trigram includes two parts, namely: an identifier (e.g., id(w3) shown in FIG. 2) of the third-order word and a trigram probability (e.g., p(w3|w1w2) shown in FIG. 2) of the trigram.

In an example, a length of the array A3 may be equal to a number m3 of trigrams enumerated.

S102: Store the N-gram language model based on the N storage structures.

After the N storage structures are constructed, the N-gram language model may be stored.

In an example, content carried by nodes in storage structures may be determined first, and then the content carried by the nodes may be written in parallel, thereby implementing the storage of the N-gram language model.

In another example, the N storage structures may be written according to a specific sequence.

In a specific example, the N storage structures may be written in sequence. Specifically, the first storage structure may be written first, and then, when i is greater than or equal to 1 and less than or equal to N−1, for information about each first gram stored in the ith storage structure, the information about the (i+1)th-order words in the plurality of (i+1)-grams that each use the first gram as the first i orders of words is written to the (i+1)th storage structure according to a storage sequence in the ith storage structure.

N=2 is taken as an example for description.

A first storage structure is written first.

In an example, the unigrams may be arranged in ascending order of identifiers of words. For each arranged unigram w, corresponding information, i.e., id(w), p(w), begin(w)=b2, and end(w)=b2+n2(w)−1, is written to the first storage structure, and b2=b2+n2(w)−1 is performed after each write, where
id(w) is an identifier of the unigram;
p(w) is a unigram probability of the unigram w;
n2(w) is a number of bigrams that each use w as a first-order word;
begin(w) is a start storage location of information about second-order words of the bigrams that each use w as the first-order word in a second storage structure; and
end(w) is an end storage location of the information about the second-order words of the bigrams that each use w as the first-order word in the second storage structure.

An initial value of b2 is 0. After the write of the first storage structure is completed, for information about a 1st first gram stored in the first storage structure, information about second-order words of a plurality of bigrams that each use the 1st first gram as the first-order word may be written to the second storage structure. Then, for information about a 2nd first gram stored in the first storage structure, information about second-order words of a plurality of bigrams that each use the 2nd first gram as the first-order word may be written to the second storage structure. By analogy, the process proceeds until information about second-order words of a plurality of bigrams that each use a last first gram in the first storage structure as the first-order word is written to the second storage structure, and at this point, the write of the second storage structure is completed.

In an example, the write, for the information about each first gram w1 stored in the first storage structure, of the information about the second-order words of the plurality of bigrams that each use the first gram (e.g., w1) as the first-order word to the second storage structure, may be specifically implemented by: arranging a set of bigrams (w1, w2) that each use w1 as the first-order word in ascending order of id(w2); and for each arranged bigram, writing corresponding element information, i.e., id(w2), p(w2|w1), begin(w1w2)=b3, end(w1w2)=b3+n3(w1w2)−1, to the second storage structure, and performing b3=b3+n3(w1w2)−1 after each write, where
id(w2) is an identifier of the second-order word;
p(w2|w1) is a bigram probability of the bigram;
begin(w1w2) is a start storage location of information about third-order words of trigrams that each use w1w2 as the first two orders of words in a third storage structure;
end(w1w2) is an end storage location of the information about the third-order words of the trigrams that each use w1w2 as the first two orders of words in the third storage structure; and
n3(w1w2) is a number of trigrams that each use w1w2 as the first two orders of words.

An initial value of b3 is 0.

Similarly, after the write of the second storage structure is completed, for information about a 1st second-order word stored in the second storage structure, information about third-order words of a plurality of trigrams that each use the 1st second-order word as the first two orders of words may be written to the third storage structure. Then, for information about a 2nd second-order word stored in the second storage structure, information about third-order words of a plurality of trigrams that each use the 2nd second-order word as the first two orders of words may be written to the third storage structure. By analogy, the process proceeds until information about third-order words of a plurality of trigrams that each use a last second-order word in the second storage structure as the first two orders of words is written to the third storage structure, and at this point, the write of the third storage structure is completed.

In an example, the write, for the information about the second-order word in each bigram stored in the second storage structure, of the information about the third-order words of the plurality of trigrams that each use the bigram (e.g., w1w2) as the first two orders of words to the third storage structure, may be specifically implemented by: arranging a set of trigrams (w1, w2, w3) that each use w1w2 as the first two orders of words in ascending order of id(w3); and for each arranged trigram (w1, w2, w3), writing corresponding element information, i.e., id(w3) and p(w3|w1w2), to the third storage structure, where
id(w3) is an identifier of the third-order word; and
p(w3|w1w2) is a trigram probability of the trigram.

It can be seen from the above description that, in the embodiments of the present application, in a case in which there are a plurality of grams, even if the first word or the first few words of the plurality of grams are the same, the same part may be stored only once rather than repeatedly. Therefore, with this solution, a storage capacity for the N-gram language model can be effectively saved, thereby improving the storage performance.

In an example, after the N-gram language model is stored, retrieval may be further performed based on the N-gram language model. In this case, the solution provided in the embodiment of the present application may further include S301 to S302 shown in FIG. 3. FIG. 3 is a schematic flowchart of a retrieval method according to an embodiment of the present application.

S301: Obtain a target search gram, where the target search gram is an M-gram, and M is less than or equal to N.

In this embodiment of the present application, after the target search gram is obtained, the target search gram may be segmented so as to obtain M words included in the target search gram.

S302: Find a first target node in a first storage structure by using an identifier of a first-order word of the M-gram as an index, and obtain information carried by the first target node.

After the target search gram is obtained, first, the first target node used to carry information about the first-order word of the M-gram may be found in the first storage structure by using the identifier of the first-order word of the M-gram as the index.

In an example, the first target node may be found in the first storage structure in a binary search manner by using the identifier of the first-order word of the M-gram as the index.

In another example, if the identifier of the first gram carried by each first node in a first array is a subscript of an element corresponding to the first node in the array, the identifier of the first-order word of the M-gram may be directly used as an array subscript, and a node that corresponds to the element corresponding to the array subscript is determined as the first target node. In this way, the first target node can be determined efficiently.

In this embodiment of the present application, after the first target node is found, the information carried by the first target node may be obtained, and the information carried by the first target node may include a unigram probability of the first-order word of the M-gram and a storage location. The storage location carried by the first target node is a storage location of second-order words of bigrams that each use the first-order word of the M-gram as the first-order word in a second storage structure.

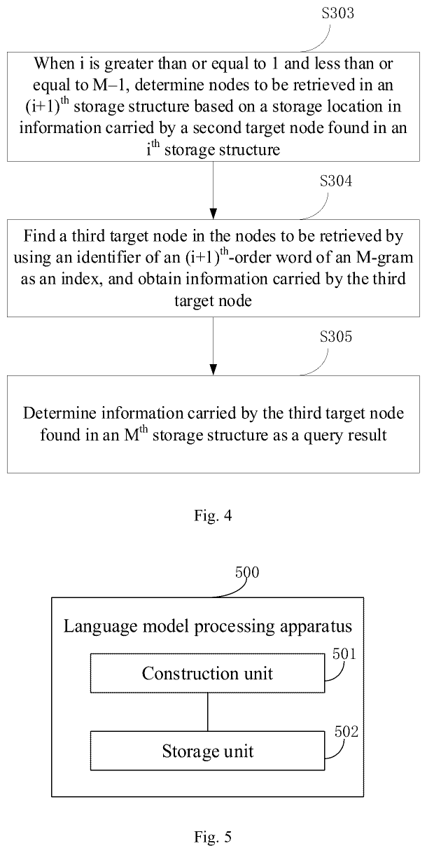

In an example, if M is greater than or equal to 2, S303 to S305 shown in FIG. 4 may be further performed after S302 is performed. FIG. 4 is a schematic flowchart of another retrieval method according to an embodiment of the present application.

S303: When i is greater than or equal to 1 and less than or equal to M−1, determine nodes to be retrieved in the (i+1)th storage structure based on a storage location in information carried by a second target node found in the ith storage structure.

S304: Find a third target node in the nodes to be retrieved by using an identifier of an (i+1)th-order word of the M-gram as an index, and obtain information carried by the third target node.

S305: Determine information carried by the third target node found in an Mth storage structure as a query result.

In an example, when the storage location in the information carried by the second target node includes a start storage location and an end storage location, nodes located between the start storage location and end storage location described above in the (i+1)th storage structure may be determined as the nodes to be retrieved.

After the nodes to be retrieved are determined, the third target node that matches the identifier of the (i+1)th-order word of the M-gram may be found in the nodes to be retrieved by using the identifier of the (i+1)th-order word of the M-gram as the index, and the information carried by the third target node may be obtained. For the information carried by the third target node, reference may be made to the above description of the information carried by the first target node, and details are not repeated herein.

After S303 and S304 are performed for the second storage structure to the Mth storage structure, information carried by the third target node found in the Mth storage structure may be determined as the query result. For example, a probability carried by the third target node may be determined as the query result.

In an example, information carried by each node to be retrieved in the Mth storage structure may be further output. In this way, all M-grams that each use first M−1 orders of words of the target search gram as first M−1 orders of words are determined without multiple searches, which allows the high retrieval efficiency.

S301 to S305 are described by way of example.

It is assumed that M is equal to 2 and the target search gram is (w1, w2), and identifiers id(w1) and id(w2) respectively corresponding to w1 and w2 are first determined. A corresponding node is found in the first storage structure by using id(w1), and location information b(w1) and e(w1) carried by the node is obtained. Nodes in a range of [b(w1), e(w1)] in the second storage structure are determined as the nodes to be retrieved, and retrieval is performed on the nodes to be retrieved by using id(w2) as an index to find a corresponding node, and obtain a probability p(w2|w1) carried by the node.

In an example, information about all nodes in the range of [b(w1), e(w1)] in the second storage structure may be directly output when all bigrams that each use w1 as the first-order word are obtained.

It is assumed that M is equal to 3 and the target search gram is (w1, w2, w3), identifiers id(w1), id(w2), and id(w3) respectively corresponding to w1, w2, and w3 are first determined. A corresponding node is found in the first storage structure by using id(w1), and location information b(w1) and e(w1) carried by the node is obtained. Nodes in a range of [b(w1), e(w1)] in the second storage structure are determined as the nodes to be retrieved, and retrieval is performed on the nodes to be retrieved by using id(w2) as an index to find a corresponding node, and obtain location information b(w1w2) and e(w1w2) carried by the node. Nodes in a range of [b(w1w2), e(w1w2)] in the third storage structure are determined as the nodes to be retrieved, and retrieval is performed on the nodes to be retrieved by using id(w3) as an index to find a corresponding node, and obtain a probability p(w3|w1w2) carried by the node.

In an example, information about all nodes in the range of [b(w1w2), e(w1w2)] in the third storage structure may be directly output when all trigrams that each use w1w2 as the first two orders of words are obtained.

On the basis of the method provided in the above embodiments, an embodiment of the present application further provides an apparatus. The apparatus will be described below with reference to the accompanying drawings.

FIG. 5 is a schematic diagram of a structure of a language model processing apparatus according to an embodiment of the present application. As shown in FIG. 5, the language model processing apparatus 500 includes: a construction unit 501 and a storage unit 502.

The construction unit 501 is configured to construct N storage structures for an N-gram language model, where N is an integer greater than or equal to 2.

The storage unit 502 is configured to store the N-gram language model based on the N storage structures.

For an ith structure of the N storage structures:
when i is greater than or equal to 1 and less than or equal to N−1, the ith storage structure includes a plurality of first nodes, each first node is used to carry information about an ith-order word in a first gram, the first gram is an i-gram, and the information carried by the first node includes: an identifier of the ith-order word in the first gram, an i-gram probability of the first gram, and a storage location of information about (i+1)th-order words in a plurality of (i+1)-grams that each use the first gram as first i orders of words in an (i+1)th storage structure, where the i-gram includes i words, the ith-order word in the i-gram is an ith word in the i-gram, the (i+1)-gram includes i+1 words, and the (i+1)th-order word in the (i+1)-gram is an (i+1)th word in the (i+1)-gram; or
when i is equal to N, the ith storage structure includes a plurality of second nodes, each second node is used to carry information about a second gram, the second gram is an N-gram, and the information carried by the second node includes: an identifier of an Nth-order word in the second gram and an N-gram probability of the second gram.

Optionally, the N storage structures are arrays, and an identifier of the first gram carried by the first node in a first array of the N arrays is a subscript of an element corresponding to the first node in the array.

Optionally, the information about the (i+1)th-order words in the plurality of (i+1)-grams that each use the first gram as the first i orders of words is continuously stored in the (i+1)th storage structure, and the storage location includes: a start storage location and an end storage location.

Optionally, the storage unit 502 is configured to:
write to a first storage structure first; and
when i is greater than or equal to 1 and less than or equal to N−1, for information about each first gram stored in the ith storage structure, write the information about the (i+1)th-order words in the plurality of (i+1)-grams that each use the first gram as the first i orders of words to the (i+1)th storage structure according to a storage sequence in the ith storage structure.

Optionally, the apparatus further includes:
an obtaining unit configured to obtain a target search gram, where the target search gram is an M-gram, and M is less than or equal to N; and
a first search unit configured to find a first target node in a first storage structure by using an identifier of a first-order word of the M-gram as an index, and obtain information carried by the first target node.

Optionally, when M is greater than or equal to 2, the apparatus further includes:
a first determination unit configured to: when i is greater than or equal to 1 and less than or equal to M−1, determine nodes to be retrieved in the (i+1)th storage structure based on a storage location in information carried by a second target node found in the ith storage structure;
a second search unit configured to find a third target node in the nodes to be retrieved by using an identifier of an (i+1)th-order word of the M-gram as an index, and obtain information carried by the third target node; and
a second determination unit configured to determine information carried by the third target node found in an Mth storage structure as a query result.

Optionally, the apparatus further includes:
an output unit configured to output information carried by each of the nodes to be retrieved in the Mth storage structure.

Since the apparatus 500 is an apparatus corresponding to the method provided in the above method embodiments, a specific implementation of each unit of the apparatus 500 belongs to the same concept as the above method embodiments. Therefore, for the specific implementation of each unit of the apparatus 500, reference may be made to the descriptions of the above method embodiments, and details are not repeated here.

An embodiment of the present application further provides a device. The device includes a processor and a memory.

The processor is configured to execute instructions stored in the memory to cause the device to perform the language model processing method provided in the above method embodiment.

An embodiment of the present application provides a computer-readable storage medium, including instructions to instruct a device to perform the language model processing method provided in the above method embodiment.

An embodiment of the present application further provides a computer program product, which, when running on a computer, causes the computer to perform the language model processing method provided in the above method embodiment.

Persons skilled in the art may readily figure out other implementation solutions of the present application after considering the specification and practicing the invention disclosed herein. The present application is intended to cover any variations, purposes, or adaptive changes of the present application. Such variations, purposes, or applicable changes follow the general principle of the present application and include common knowledge or conventional technical means in the art which is not disclosed in the present disclosure. The specification and embodiments are merely considered as examples, and the true scope and spirit of the present application are defined by the appended claims.

It should be understood that the present application is not limited to the exact structure that has been described above and shown in the accompanying drawings, and various modifications and changes may be made without departing from the scope of the present application. The scope of the present application is defined only by the appended claims.

The above description is only the preferred embodiments of the present application and is not intended to limit the present application. Any modifications, equivalent substitutions, improvements, etc. made within the spirit and principles of the present application shall fall within the scope of protection of the present application.

1. A language model processing method, comprising:
constructing N storage structures for an N-gram language model, wherein N is an integer greater than or equal to 2; and
storing the N-gram language model based on the N storage structures, wherein
for an ith structure of the N storage structures:
when i is greater than or equal to 1 and less than or equal to N−1, the ith storage structure comprises a plurality of first nodes, each first node is used to carry information about an ith-order word in a first gram, the first gram is an i-gram, and the information carried by the first node comprises: an identifier of the ith-order word in the first gram, an i-gram probability of the first gram, and a storage location of information about (i+1)th-order words in a plurality of (i+1)-grams that each use the first gram as first i orders of words in an (i+1)th storage structure, wherein the i-gram comprises i words, the ith-order word in the i-gram is an ith word in the i-gram, the (i+1)-gram comprises i+1 words, and the (i+1)th-order word in the (i+1)-gram is an (i+1)th word in the (i+1)-gram; or
when i is equal to N, the ith storage structure comprises a plurality of second nodes, each second node is used to carry information about a second gram, the second gram is an N-gram, and the information carried by the second node comprises: an identifier of an Nth-order word in the second gram and an N-gram probability of the second gram.

2. The method according to claim 1, wherein the N storage structures are arrays, and an identifier of the first gram carried by the first node in a first array of the N arrays is a subscript of an element corresponding to the first node in the array.

3. The method according to claim 2, wherein the information about the (i+1)th-order words in the plurality of (i+1)-grams that each use the first gram as the first i orders of words is continuously stored in the (i+1)th storage structure, and the storage location comprises: a start storage location and an end storage location.

4. The method according to claim 1, wherein the storing the N-gram language model based on the N storage structures comprises:
writing to a first storage structure first; and
when i is greater than or equal to 1 and less than or equal to N−1, for information about each first gram stored in the ith storage structure, writing the information about the (i+1)th-order words in the plurality of (i+1)-grams that each use the first gram as the first i orders of words to the (i+1)th storage structure according to a storage sequence in the ith storage structure.

5. The method according to claim 1, wherein the method further comprises:
obtaining a target search gram, wherein the target search gram is an M-gram, and M is less than or equal to N; and
finding a first target node in a first storage structure by using an identifier of a first-order word of the M-gram as an index, and obtaining information carried by the first target node.

6. The method according to claim 5, wherein when M is greater than or equal to 2, the method further comprises:
when i is greater than or equal to 1 and less than or equal to M−1, determining nodes to be retrieved in the (i+1)th storage structure based on a storage location in information carried by a second target node found in the ith storage structure;
finding a third target node in the nodes to be retrieved by using an identifier of an (i+1)th-order word of the M-gram as an index, and obtaining information carried by the third target node; and
determining information carried by the third target node found in an Mth storage structure as a query result.

7. The method according to claim 6, wherein the method further comprises:
outputting information carried by each of the nodes to be retrieved in the Mth storage structure.

8. A language model processing device, comprising a processor and a memory, wherein
the processor is configured to execute instructions stored in the memory to cause the device to perform a language model processing method, which comprises:
constructing N storage structures for an N-gram language model, wherein N is an integer greater than or equal to 2; and
storing the N-gram language model based on the N storage structures, wherein
for an ith structure of the N storage structures:
when i is greater than or equal to 1 and less than or equal to N−1, the ith storage structure comprises a plurality of first nodes, each first node is used to carry information about an ith-order word in a first gram, the first gram is an i-gram, and the information carried by the first node comprises: an identifier of the ith-order word in the first gram, an i-gram probability of the first gram, and a storage location of information about (i+1)th-order words in a plurality of (i+1)-grams that each use the first gram as first i orders of words in an (i+1)th storage structure, wherein the i-gram comprises i words, the ith-order word in the i-gram is an ith word in the i-gram, the (i+1)-gram comprises i+1 words, and the (i+1)th-order word in the (i+1)-gram is an (i+1)th word in the (i+1)-gram; or
when i is equal to N, the ith storage structure comprises a plurality of second nodes, each second node is used to carry information about a second gram, the second gram is an N-gram, and the information carried by the second node comprises: an identifier of an Nth-order word in the second gram and an N-gram probability of the second gram.

9. The language model processing device according to claim 8, wherein the N storage structures are arrays, and an identifier of the first gram carried by the first node in a first array of the N arrays is a subscript of an element corresponding to the first node in the array.

10. The language model processing device according to claim 9, wherein the information about the (i+1)th-order words in the plurality of (i+1)-grams that each use the first gram as the first i orders of words is continuously stored in the (i+1)th storage structure, and the storage location comprises: a start storage location and an end storage location.

11. The language model processing device according to claim 8, wherein the storing the N-gram language model based on the N storage structures comprises:
writing to a first storage structure first; and
when i is greater than or equal to 1 and less than or equal to N−1, for information about each first gram stored in the ith storage structure, writing the information about the (i+1)th-order words in the plurality of (i+1)-grams that each use the first gram as the first i orders of words to the (i+1)th storage structure according to a storage sequence in the ith storage structure.

12. The language model processing device according to claim 8, wherein the method further comprises:
obtaining a target search gram, wherein the target search gram is an M-gram, and M is less than or equal to N; and
finding a first target node in a first storage structure by using an identifier of a first-order word of the M-gram as an index, and obtaining information carried by the first target node.

13. The language model processing device according to claim 12, wherein when M is greater than or equal to 2, the method further comprises:
when i is greater than or equal to 1 and less than or equal to M−1, determining nodes to be retrieved in the (i+1)th storage structure based on a storage location in information carried by a second target node found in the ith storage structure;
finding a third target node in the nodes to be retrieved by using an identifier of an (i+1)th-order word of the M-gram as an index, and obtaining information carried by the third target node; and
determining information carried by the third target node found in an Mth storage structure as a query result.

14. The language model processing device according to claim 13, wherein the method further comprises:
outputting information carried by each of the nodes to be retrieved in the Mth storage structure.

15. A non-transitory computer-readable storage medium, comprising instructions to instruct a device to perform a language model processing method, which comprises:
constructing N storage structures for an N-gram language model, wherein N is an integer greater than or equal to 2; and
storing the N-gram language model based on the N storage structures, wherein
for an ith structure of the N storage structures:
when i is greater than or equal to 1 and less than or equal to N−1, the ith storage structure comprises a plurality of first nodes, each first node is used to carry information about an ith-order word in a first gram, the first gram is an i-gram, and the information carried by the first node comprises: an identifier of the ith-order word in the first gram, an i-gram probability of the first gram, and a storage location of information about (i+1)th-order words in a plurality of (i+1)-grams that each use the first gram as first i orders of words in an (i+1)th storage structure, wherein the i-gram comprises i words, the ith-order word in the i-gram is an ith word in the i-gram, the (i+1)-gram comprises i+1 words, and the (i+1)th-order word in the (i+1)-gram is an (i+1)th word in the (i+1)-gram; or
when i is equal to N, the ith storage structure comprises a plurality of second nodes, each second node is used to carry information about a second gram, the second gram is an N-gram, and the information carried by the second node comprises: an identifier of an Nth-order word in the second gram and an N-gram probability of the second gram.

16. The non-transitory computer-readable storage medium according to claim 15, wherein the N storage structures are arrays, and an identifier of the first gram carried by the first node in a first array of the N arrays is a subscript of an element corresponding to the first node in the array.

17. The non-transitory computer-readable storage medium according to claim 16, wherein the information about the (i+1)th-order words in the plurality of (i+1)-grams that each use the first gram as the first i orders of words is continuously stored in the (i+1)th storage structure, and the storage location comprises: a start storage location and an end storage location.

18. The non-transitory computer-readable storage medium according to claim 15, wherein the storing the N-gram language model based on the N storage structures comprises:
writing to a first storage structure first; and
when i is greater than or equal to 1 and less than or equal to N−1, for information about each first gram stored in the ith storage structure, writing the information about the (i+1)th-order words in the plurality of (i+1)-grams that each use the first gram as the first i orders of words to the (i+1)th storage structure according to a storage sequence in the ith storage structure.

19. The non-transitory computer-readable storage medium according to claim 15, wherein the method further comprises:
obtaining a target search gram, wherein the target search gram is an M-gram, and M is less than or equal to N; and
finding a first target node in a first storage structure by using an identifier of a first-order word of the M-gram as an index, and obtaining information carried by the first target node.

20. The non-transitory computer-readable storage medium according to claim 19, wherein when M is greater than or equal to 2, the method further comprises:
when i is greater than or equal to 1 and less than or equal to M−1, determining nodes to be retrieved in the (i+1)th storage structure based on a storage location in information carried by a second target node found in the ith storage structure;
finding a third target node in the nodes to be retrieved by using an identifier of an (i+1)th-order word of the M-gram as an index, and obtaining information carried by the third target node; and
determining information carried by the third target node found in an Mth storage structure as a query result.
